(19) United States
(12) Patent Application Publication
(10) Pub. No.: US 2024/0244562 A1
(43) Pub. Date: Jul. 18, 2024

(54) MESH-BASED POSITIONING

(71) Applicant: Samsung Electronics Co., Ltd., Suwon-si (KR)

(72) Inventor: Emad Nader Farag, Flanders, NJ (US)

(21) Appl. No.: 18/395,328

(22) Filed: Dec. 22, 2023

Related U.S. Application Data
(60) Provisional application No. 63/437,076, filed on Jan. 4, 2023.

(51) Int. Cl. H04W 64/00; H04L 5/00

(52) U.S. Cl. CPC H04W 64/00; H04L 5/0048

(57) ABSTRACT

Methods and apparatuses for mesh-based positioning operations in a wireless communication system. A method of operating a user equipment (UE) includes receiving first sidelink (SL) positioning reference signals (PRSs) from M1 UEs, respectively, where M1>=2; determining positioning metrics based on the first SL PRSs; determining a first report; and transmitting the first report to a third UE or one of the M1 UEs. The first report includes the positioning metrics corresponding to M2 UEs, respectively, from the M1 UEs; time-stamps associated with the positioning metrics, respectively; and identities (IDs) of the M2 UEs, respectively.

### CROSS-REFERENCE TO RELATED APPLICATIONS AND CLAIM OF PRIORITY

The present application claims priority to U.S. Provisional Patent Application No. 63/437,076, filed on Jan. 4, 2023. The contents of the above-identified patent document are incorporated herein by reference.

### TECHNICAL FIELD

The present disclosure relates generally to wireless communication systems and, more specifically, the present disclosure relates to a mesh-based positioning operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a mesh-based positioning operation in a wireless communication system.

In one embodiment, a user equipment (UE) is provided. The UE includes a transceiver configured to receive first sidelink (SL) positioning reference signals (PRSs) from M1 UEs, respectively, where M1>=2. The UE further includes a processor operably coupled to the transceiver. The processor is configured to determine positioning metrics based on the first SL PRSs, and determine a first report. The first report includes the positioning metrics corresponding to M2 UEs, respectively, from the M1 UEs; time-stamps associated with the positioning metrics, respectively; and identities (IDs) of the M2 UEs, respectively. The transceiver is further configured to transmit the first report to a third UE or one of the M2 UEs.

In another embodiment, a base station (BS) is provided. The BS includes a processor and a transceiver operably coupled to the processor. The transceiver is configured to transmit a configuration indicating resources and receive a report via the resources. The report includes positioning metrics corresponding to M UEs, respectively, where M>=1, time-stamps associated with the positioning metrics, respectively, and IDs of the M UEs, respectively.

In yet another embodiment, a method of operating a UE is provided. The method includes receiving first SL PRSs from M1 UEs, respectively, where M1>=2; determining positioning metrics based on the first SL PRSs; determining a first report; and transmitting the first report to a third UE or one of the M2 UEs. The first report includes the positioning metrics corresponding to M2 UEs, respectively, from the M1 UEs; time-stamps associated with the positioning metrics, respectively; and IDs of the M2 UEs, respectively.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The term “module” means any device, system, or part thereof that controls at least one operation. Such a module may be implemented in hardware or a combination of hardware and software and/or firmware. The functionality associated with any particular module may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of network positioning architecture according to embodiments of the present disclosure;

FIG. 7 illustrates an example of LMF according to embodiments of the present disclosure;

FIG. 8 illustrates an example of UE is in a coverage of a network according to embodiments of the present disclosure;

FIG. 9 illustrates an example of multiple UEs according to embodiments of the present disclosure; and

FIG. 10 illustrates an example method performed by a UE in a wireless communication system according to embodiments of the present disclosure.

### DETAILED DESCRIPTION

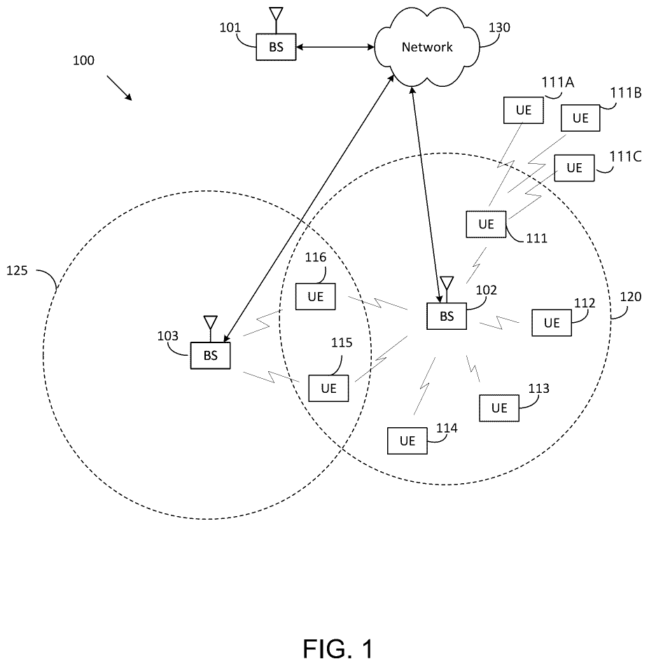

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v18.0.0, “NR; Physical channels and modulation”; 3GPP TS 38.212 v18.0.0, “NR; Multiplexing and Channel coding”; 3GPP TS 38.213 v18.0.0, “NR; Physical Layer Procedures for Control”; 3GPP TS 38.214 v18.0.0, “NR; Physical Layer Procedures for Data”; 3GPP TS 38.215 v18.0.0, “NR; Physical Layer Measurements”; 3GPP TS 38.321 v17.6.0, “NR; Medium Access Control (MAC) protocol specification”; 3GPP TS 38.331 v17.6.0, “NR; Radio Resource Control (RRC) Protocol Specification”; 3GPP TS 36.213 v18.0.0, “Evolved Universal Terrestrial Radio Access (E-UTRA); Physical layer procedures,” and 3GPP TR 38.845 v17.0.0, “Study on scenarios and requirements of in-coverage, partial coverage, and out-of-coverage NR positioning use cases.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, RAT-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for sending and/or receiving a signaling for a mesh-based positioning operation in a wireless communication system. In certain embodiments, and one or more of the gNBs 101-103 includes circuitry, programing, or a combination thereof, to support a mesh-based positioning in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication and/or SL positioning with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication and/or positioning with their other UEs (such as UEs 111A to 111C as for UE 111).

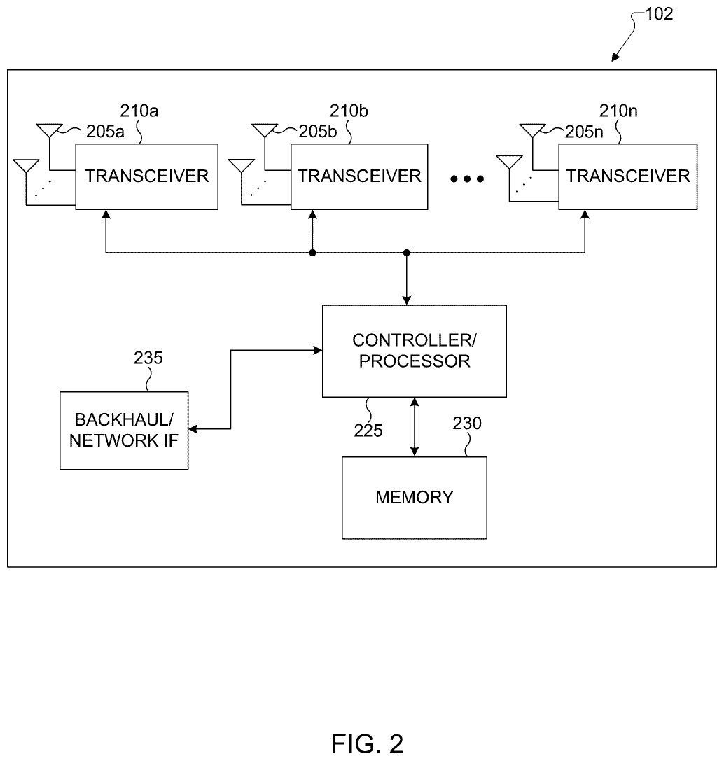

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels and/or signals and the transmission of DL channels and/or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for to provide or support a mesh-based positioning in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

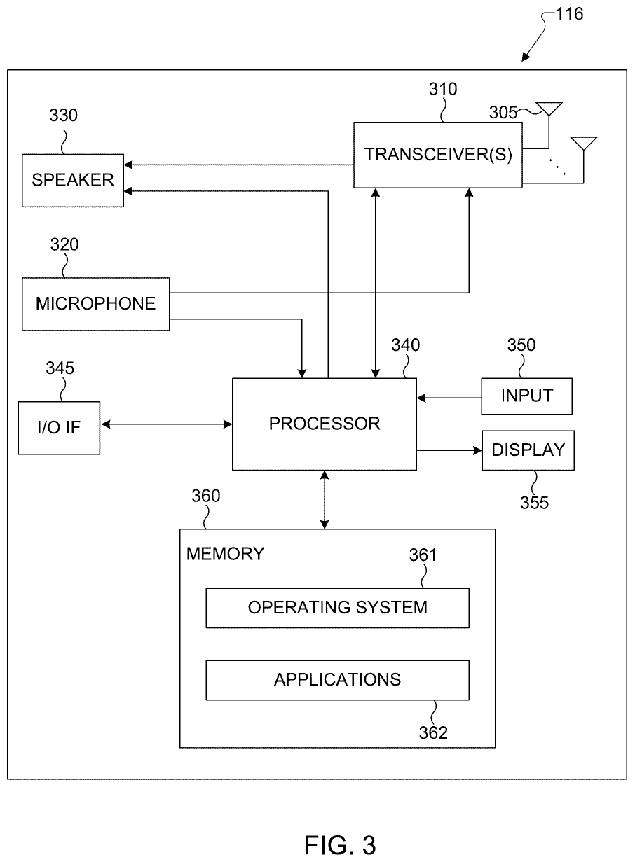

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels and/or signals or SL channels and/or signals and the transmission of UL channels and/or signals or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for mesh-based positioning operations in a wireless communication system. The processor 340 can move data into or out of the memory 360 as required by an executing process. In some embodiments, the processor 340 is configured to execute the applications 362 based on the OS 361 or in response to signals received from gNBs or another SL UE or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

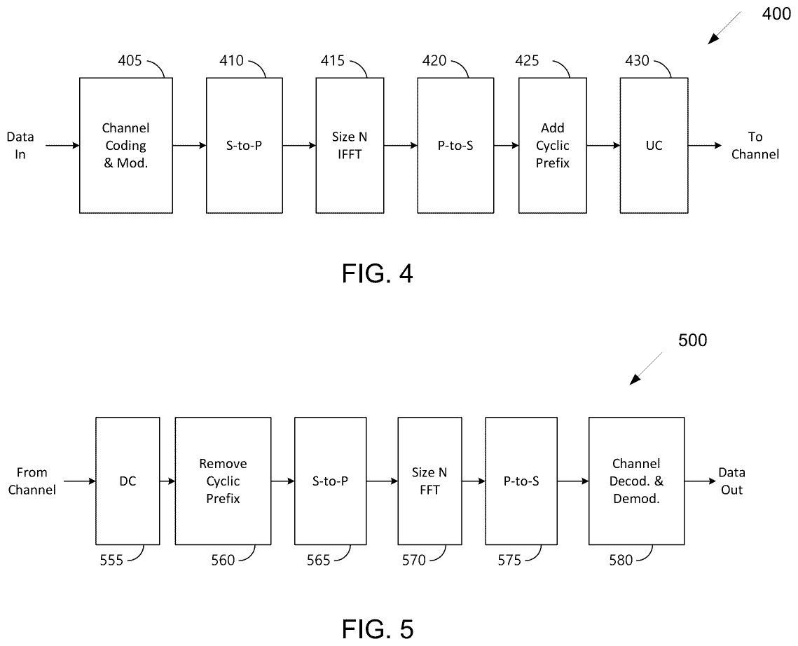

FIG. 4 and FIG. 5 illustrate example wireless transmit and receive paths according to the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in a first UE and that the transmit path 400 can be implemented in a second UE to support a mesh-based positioning operation in a wireless communication system. In some embodiments, the transmit path 400 and the receive path 500 are configured to support a mesh-based positioning operation in a wireless communication system as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102, or UE 115 arrives at the UE 116 after passing through the wireless channel, and reverse operations to those at the gNB 102 or UE 115 are performed at the UE 116. A transmitted RF signal from a first UE arrives at a second UE after passing through the wireless channel, and reverse operations to those at the first UE are performed at the second UE.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or for transmitting in the sidelink to another UE and may implement the receive path 500 for receiving in the downlink from the gNBs 101-103 or for receiving in the in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols and an RB can have a BW of 720 kHz and include 12 SCs with SC spacing of 60 KHz. An RB in one symbol of a slot is referred to as physical RB (PRB) and includes a number of resource elements (REs). A slot can be either full DL slot, or full UL slot, or hybrid slot similar to a special subframe in time division duplex (TDD) systems. In addition, a slot can have symbols for SL communications and/or SL positioning. A UE can be configured one or more bandwidth parts (BWPs) of a system BW for transmissions or receptions of signals or channels.

An NR supports positioning on the Uu interface. In the DL, positioning reference signal (PRS) can be transmitted by a gNB to a UE to enable the UE to perform positioning measurements. In the UL a UE can transmit positioning sounding reference signal (SRS) to enable a gNB to perform positioning measurements. UE measurements or metrics for positioning include; DL PRS reference signal received power (DL PRS RSRP), DL PRS reference signal received path power (DL PRS-RSRPP), DL reference signal time difference (DL RSTD), UE Rx-Tx time difference, DL reference signal carrier phase (DL RSCP), DL reference signal carrier phase difference (DL RSCPD) NR enhanced cell ID (E-CID), DL SSB radio resource management (RRM) measurement, and NR E-CID DL CSI-RS RRM measurement. UE measurements for positioning on the SL interface include; sidelink PRS reference signal received power (SL PRS-RSRP), sidelink PRS reference signal received path power (SL PRS-RSRPP), sidelink relative time of arrival (SL-RTOA), sidelink angle of arrival (SL AoA), sidelink Rx-Tx time difference, and sidelink reference signal time difference (SL RSTD). NG-RAN measurements for positioning include; UL relative time of arrival (UL-RTOA), UL angle of arrival (UL AoA), UL SRS reference signal received power (UL SRS-RSRP), UL SRS reference signal received path power (UL SRS-RSRPP), gNB Rx-Tx time difference, and UL reference signal carrier phase (UL RSCP). NR introduced several RAT dependent positioning methods; time difference of arrival based methods such DL time difference of arrival (DL-TDOA), UL time difference of arrival (UL TDOA) and SL time difference of arrival (SL TDOA), angle based methods such as UL angle of arrival (UL AoA), DL angle of departure (DL AoD) and SL angle of arrival (SL AoA), multi-round trip time (RTT) based methods for Uu interface and SL interface and E-CID based methods.

Positioning schemes can be UE-based, i.e., the UE determines the location or UE-assisted (e.g., location management function (LMF) based), i.e., UE provides measurements for a network entity (e.g., LMF) to determine the location, or NG-RAN node assisted (i.e., NG-RAN node such as gNB provides measurement to LMF). LTE positioning protocol (LPP), as illustrated in 3GPP standard specification TS 37.355, first introduce for LTE and then extended to NR is used for communication between the UE and LMF. NR positioning protocol annex (NRPPa), as illustrated in 3GPP standard specification TS 38.455, is used for communication between the gNB and the LMF.

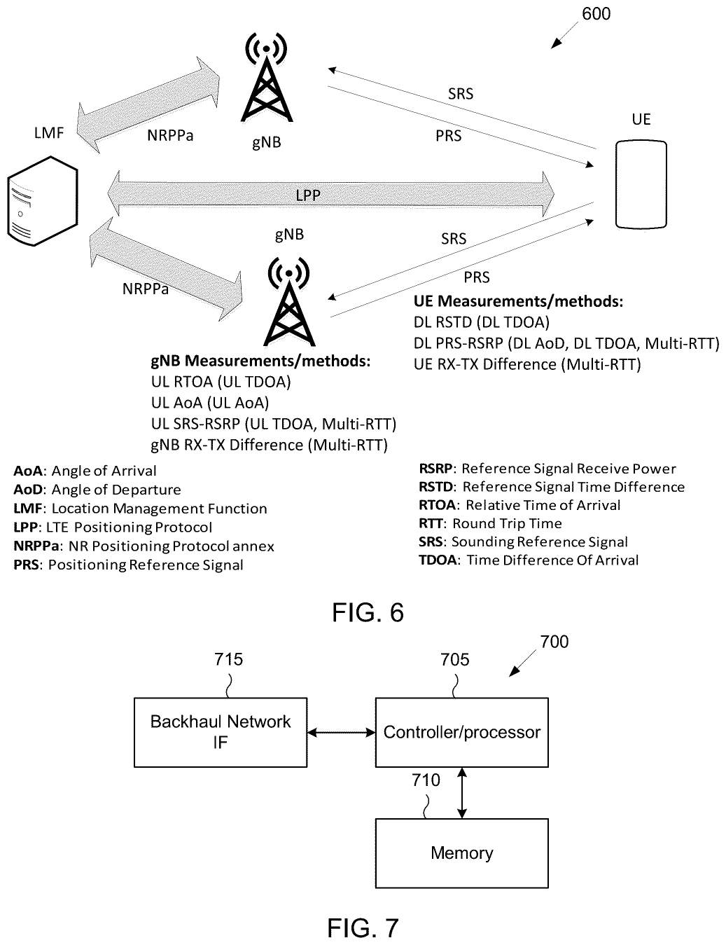

FIG. 6 illustrates an example of network positioning architecture 600 according to embodiments of the present disclosure. An embodiment of the network positioning architecture 600 shown in FIG. 6 is for illustration only. FIG. 6 illustrates the overall positioning architecture along with positioning measurements and methods.

SL signals and channels are transmitted and received on sub-channels within a resource pool, where a resource pool is a set of time-frequency resources used for SL transmission and reception within a SL BWP. SL channels include physical SL shared channels (PSSCHs) conveying data information and second stage/part SL control information (SCI), physical SL control channels (PSCCHs) conveying first stage/part SCI for scheduling transmissions/receptions of PSSCHs, physical SL feedback channels (PSFCHs) conveying hybrid automatic repeat request acknowledgement (HARQ-ACK) information in response to correct (ACK value) or incorrect (NACK value) transport block receptions in respective PSSCHs, PSFCHs can also convey conflict information, and physical SL broadcast channel (PSBCH) conveying system information to assist in SL synchronization.

SL signals include demodulation reference signals DM-RS that are multiplexed in PSSCH or PSCCH transmissions to assist with data or SCI demodulation, channel state information reference signals (CSI-RS) for channel measurements, phase tracking reference signals (PT-RS) for tracking a carrier phase, and SL primary synchronization signals (S-PSS) and SL secondary synchronization signals (S-SSS) for SL synchronization. SCI can include two parts/stages corresponding to two respective SCI formats where, for example, the first SCI format is multiplexed on a PSCCH and the second SCI format is multiplexed along with SL data on a PSSCH that is transmitted in physical resources indicated by the first SCI format.

A SL channel can operate in different cast modes. In a unicast mode, a PSCCH/PSSCH conveys SL information from one UE to only one other UE. In a groupcast mode, a PSCCH/PSSCH conveys SL information from one UE to a group of UEs within a (pre-)configured set. In a broadcast mode, a PSCCH/PSSCH conveys SL information from one UE to all surrounding UEs. In NR release 16, there are two resource allocation modes for a PSCCH/PSSCH transmission. In resource allocation mode 1, a gNB schedules a UE on the SL and conveys scheduling information to the UE transmitting on the SL through a DCI format (e.g., DCI Format 3_0) transmitted from the gNB on the DL. In resource allocation mode 2, a UE schedules a SL transmission. SL transmissions can operate within network coverage where each UE is within the communication range of a gNB, outside network coverage where all UEs have no communication with any gNB, or with partial network coverage, where only some UEs are within the communication range of a gNB.

In case of groupcast PSCCH/PSSCH transmission, a UE can be (pre-)configured one of two options for reporting of HARQ-ACK information by the UE: (1) HARQ-ACK reporting option 1, a UE can attempt to decode a transport block (TB) in a PSSCH reception if, for example, the UE detects a SCI format scheduling the TB reception through a corresponding PSSCH. If the UE fails to correctly decode the TB, the UE multiplexes a negative acknowledgement (NACK) in a PSFCH transmission. In this option, the UE does not transmit a PSFCH with a positive acknowledgment (ACK) when the UE correctly decodes the TB; and (2) HARQ-ACK reporting option 2, a UE can attempt to decode a TB if, for example, the UE detects a SCI format that schedules a corresponding PSSCH. If the UE correctly decodes the TB, the UE multiplexes an ACK in a PSFCH transmission; otherwise, if the UE does not correctly decode the TB, the UE multiplexes a NACK in a PSFCH transmission.

In HARQ-ACK reporting option 1, when a UE that transmitted the PSSCH detects a NACK in a PSFCH reception, the UE can transmit another PSSCH with the TB (retransmission of the TB). In HARQ-ACK reporting option 2 when a UE that transmitted the PSSCH does not detect an ACK in a PSFCH reception, such as when the UE detects a NACK or does not detect a PSFCH reception, the UE can transmit another PSSCH with the TB.

A sidelink resource pool includes a set/pool of slots and a set/pool of RBs used for sidelink transmission and sidelink reception. A set of slots which belong to a sidelink resource pool can be denoted by {t′₀^{SL}, t′₁^{SL}, t′₂^{SL}, . . . , t′_{T′}_{_{MAX}}₋₁^{SL}} and can be configured, for example, at least using a bitmap. Where, T′_{MAX} is the number of SL slots in a resource pool, e.g., in 1024 frames. Within each slot t′_{y}^{SL} of a sidelink resource pool, there are N_{subCH} contiguous sub-channels in the frequency domain for sidelink transmission, where N_{subCH} is provided by a higher-layer parameter. Subchannel m, where m is between 0 and N_{subCH}−1, is given by a set of n_{subCHsize} contiguous PRBs, given by n_{PRB}=n_{subCHstart}+m+. n_{subCHsize}+j, where j=0, 1, . . . , n_{subCHsize}−1, nsubCHstart and nsubCHsize are provided by higher layer parameters.

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤ T_{proc,1}^{SL}, where T_{proc,1}^{SL} is a PSSCH processing time for example as defined in TS 38.214. T₂ is determined by the UE such that T₂ₘᵢₙ≤T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission. The slots of a SL resource pool are determined as shown in TABLE 1.

TABLE 1

| | |
|---|---|
| 1. | Let set of slots that may belong to a resource be denoted by {t₀^{SL}, t₁^{SL}, t₂^{SL}, . . . , t_{T}_{_{MAX}}₋₁^{SL}}, |
| | where 0 ≤ tᵢ^{SL} < 10240 × 2^{μ}, and 0 ≤ i < Tₘₐₓ. μ is the sub-carrier spacing |
| | configuration. μ = 0 for a 15 kHz sub-carrier spacing. μ = 1 for a 30 kHz sub-carrier |
| | spacing. μ = 2 for a 60 kHz sub-carrier spacing. μ = 3 for a 120 kHz sub-carrier |
| | spacing. The slot index is relative to slot#0 of system frame number (SFN)#0 of the |
| | serving cell, or direct frame number (DFN)#0 (direct frame number 0). The set of slots |
| | includes all slots except: |
| | a. N_{S-SSB} slots that are configured for SL SS/PBCH Block (S-SSB). |
| | b. N_{nonSL} slots where at least one SL symbol is not not-semi-statically configured |
| | as UL symbol by higher layer parameter tdd-UL-DL-ConfigurationCommon or |
| | sl-TDD-Configuration. In a SL slot, OFDM symbols Y-th, (Y + 1)-th, . . . , (Y + |
| | X − 1)-th are SL symbols, where Y is determined by the higher layer parameter sl- |
| | StartSymbol and X is determined by higher layer parameter sl-LengthSymbols. |
| | c. N_{reserved} reserved slots. Reserved slots are determined such that the slots in the |
| | set {t₀^{SL}, t₁^{SL}, t₂^{SL}, . . . , t_{T}_{_{MAX}}₋₁^{SL}} is a multiple of the bitmap length (L_{bitmap}), where |
| | the bitmap (b₀, b₁, . . . , b_{L}_{_{bitmap}}₋₁) is configured by higher layers. The reserved |
| | slots are determined as follows: |
| | i. Let {l₀, l₁, . . . , l₂_{^{μ}}_{×10240-N}_{_{S−SSB}}_{-N}_{_{nonSL}}₋₁} be the set of slots in range 0. . . 2^{μ} × |
| | 10240 − 1, excluding S−SSB slots and non-SL slots. The slots are |
| | arranged in ascending order of the slot index. |
| | ii. The number of reserved slots is given by: N_{reserved} = |
| | (2^{μ} × 10240 − N_{S-SSB}− N_{nonSL}) mod L_{bitmap}. |
| | $iii . The reserved slots {l}_{r} are given by \text{:} r = ⌊ \frac{m \cdot ( {2}^{μ} \times 10240 - {N}_{S - SSB} - {N}_{nonSL} )}{{N}_{reserved}} ⌋ ,$ |
| | where m = 0, 1, . . . , N_{rereserved-1} |
| | Tₘₐₓ is given by: Tₘₐₓ = 2^{μ} × 10240 − N_{S-SSB}− N_{nonSL} − N_{reserved}. |
| 2. | The slots are arranged in ascending order of slot index. |
| 3. | The set of slots belonging to the SL resource pool, {t′₀^{SL}, t′₁^{SL}, t′₂^{SL}, . . . , t′_{T′}_{_{MAX}}₋₁^{SL}}, |
| | are determined as follows: |
| | a. Each resource pool has a corresponding bitmap (b₀, b₁, . . . , b_{L}_{_{bitmap}}₋₁) |
| | of length L_{bitmap}. |
| | b. A slot tₖ^{SL} belongs to the SL resource pool if b_{k mod L}_{_{bitmap}} = 1 |
| | c. The remaining slots are indexed successively staring from 0, 1, . . . T′_{MAX} − 1. |
| | Where, T′_{MAX} is the number of remaining slots in the set. |

Slots can be numbered (indexed) as physical slots or logical slots, wherein physical slots include all slots numbered sequential, while logical slots include only slots that are allocated to sidelink resource pool as described above numbered sequentially. The conversion from a physical duration, Pᵣₛᵥₚ, in milli-second to logical slots, P′ᵣₛᵥₚ, is given by

$${P}_{rsvp}^{′} = ⌈ \frac{T {′}_{max}}{10240 ms} \times {P}_{rsvp} ⌉$$

(as illustrated in 3GPP standard specification 38.214).

For resource (re-)selection or re-evaluation in slot n, a UE can determine a set of available single-slot resources for transmission within a resource selection window [n+T₁, n+T₂], such that a single-slot resource for transmission, R_{x,y} is defined as a set of L_{subCH} contiguous subchannels x+i, where i=0, 1, . . . , L_{subCH}−1 in slot t_{y}^{SL}. T₁ is determined by the UE such that, 0≤T₁≤ T_{proc,1}^{SL}, where T_{proc,1}^{SL} is a PSSCH processing time for example as defined 3GPP standard specification (TS 38.214). T₂ is determined by the UE such that T₂ₘᵢₙ≤ T₂≤Remaining Packet Delay Budget, as long as T₂ₘᵢₙ<Remaining Packet Delay Budget, else T₂ is equal to the Remaining Packet Delay Budget. T₂ₘᵢₙ is configured by higher layers and depends on the priority of the SL transmission.

The resource (re-)selection is a two-step procedure: (1) the first step (e.g., performed in the physical layer) is to identify the candidate resources within a resource selection window. Candidate resources are resources that belong to a resource pool, but exclude resources (e.g., resource exclusion) that were previously reserved, or potentially reserved by other UEs. The resources excluded are based on SCIs decoded in a sensing window and for which the UE measures a SL RSRP that exceeds a threshold. The threshold depends on the priority indicated in a SCI format and on the priority of the SL transmission. Therefore, sensing within a sensing window involves decoding the first stage SCI, and measuring the corresponding SL RSRP, wherein the SL RSRP can be based on PSCCH DMRS or PSSCH DMRS. Sensing is performed over slots where the UE doesn't transmit SL. The resources excluded are based on reserved transmissions or semi-persistent transmissions that can collide with the excluded resources or any of reserved or semi-persistent transmissions; the identified candidate resources after resource exclusion are provided to higher layers and (2) the second step (e.g., preformed in the higher layers) is to select or re-select a resource from the identified candidate resources for PSSCH/PSCCH transmission.

During the first step of the resource (re-)selection procedure, a UE can monitor slots in a sensing window [n−T₀, n−T_{proc,0}), where the UE monitors slots belonging to a corresponding sidelink resource pool that are not used for the UE's own transmission. To determine a candidate single-slot resource set to report to higher layers, a UE excludes (e.g., resource exclusion) from the set of available single-slot resources for SL transmission within a resource pool and within a resource selection window as shown in TABLE 2.

TABLE 2

| | |
|---|---|
| 1. | Single slot resource R_{x,y}, such that for any slot t′ₘ^{SL} not monitored within the |
| | sensing window with a hypothetical received SCI Format 1-0, with a |
| | “Resource reservation period” set to any periodicity value allowed by a higher |
| | layer parameter reservationPeriodAllowed, and indicating all sub-channels of the |
| | resource pool in this slot, satisfies condition 2.2. below. |
| 2. | Single slot resource R_{x,y}, such that for any received SCI within the sensing window: |
| | 1. The associated L1-RSRP measurement is above a (pre-)configured |
| | SL-RSRP threshold, where the SL-RSRP threshold depends on the priority |
| | indicated in the received SCI and that of the SL transmission for which |
| | resources are being selected. |
| | 2. (Condition 2.2) The received SCI in slot t′ₘ^{SL}, or if “Resource reservation |
| | field” is present in the received SCI the same SCI is assumed to be received |
| | in slot t′_{m+q×P′}_{ᵣₛᵥₚ}_Rx^{SL}, indicates a set of resource blocks that overlaps |
| | R_{x,y+j×P′}_{ᵣₛᵥₚ}_Tx. Where, |
| | q = 1, 2, . . . , Q, where, |
| | $If {P}_{rsvp \_ RX} \leq {T}_{scal} and {n}^{′} - m < {P}_{rsvp \_ Rx}^{′} \to Q = ⌈ \frac{{T}_{scal}}{{P}_{rsvp \_ RX}} ⌉ .$ |
| | T_{scal} is T₂ in units of milli-seconds. |
| | Else Q = 1 |
| | If n belongs to (t′₀^{SL}, t′₁^{SL}, . . . , t′_{T′}_{_{max−1}}^{SL}), n′ = n, else n′ is the |
| | first slot after slot n belonging to set (t′₀^{SL}, t′₁^{SL}, . . . , t′_{T′}_{_{max−1}}^{SL}). |
| | j = 0, 1, . . . , Cᵣₑₛₑₗ − 1 |
| | Pᵣₛᵥₚ_RX is the indicated resource reservation period in the received SCI |
| | in physical slots, and P′ᵣₛᵥₚ_Rx is that value converted to logical slots. |
| | P′ᵣₛᵥₚ_Tx is the resource reservation period of the SL transmissions for |
| | which resources are being reserved in logical slots. |
| 3. | If the candidate resources are less than a (pre-)configured percentage, such as |
| | 20%, of the total available resources within the resource selection window, the |
| | (pre-)configured SL-RSRP thresholds are increased by a predetermined amount, |
| | such as 3 dB and the above steps are repeated. |

NR sidelink introduced two new procedures for mode 2 resource allocation; re-evaluation and pre-emption.

Re-evaluation check occurs when a UE checks the availability of pre-selected SL resources before the resources are first signaled in an SCI Format, and if needed re-selects new SL resources. For a pre-selected resource to be first-time signaled in slot m, the UE performs a re-evaluation check at least in slot m−T₃.

The re-evaluation check includes: (1) performing the first step of the SL resource selection procedure (as illustrated in 3GPP standard specification 38.214), which involves identifying a candidate (e.g., available) sidelink resource set in a resource selection window as previously described; (2) if the pre-selected resource is available in the candidate sidelink resource set, the resource is used/signaled for sidelink transmission; and (3) else, the pre-selected resource is not available in the candidate sidelink resource set, a new sidelink resource is re-selected from the candidate sidelink resource set.

A pre-emption check occurs when a UE checks the availability of pre-selected SL resources that have been previously signaled and reserved in an SCI Format, and if needed re-selects new SL resources. For a pre-selected and reserved resource to be signaled in slot m, the UE performs a pre-emption check at least in slot m−T₃.

When pre-emption check is enabled by higher layers, a pre-emption check includes: (1) performing the first step of the SL resource selection procedure (as illustrated in 3GPP standard specification 38.214), which involves identifying candidate (e.g., available) sidelink resource set in a resource selection window as previously described; (2) if the pre-selected and reserved resource is available in the candidate sidelink resource set, the resource is used/signaled for sidelink transmission; and (3) else, the pre-selected and reserved resource is NOT available in the candidate sidelink resource set. The resource is excluded from the candidate resource set due to an SCI, associated with a priority value P_{RX}, having an RSRP exceeding a threshold. Let the priority value of the sidelink resource being checked for pre-emption be P_{TX}.

If the priority value P_{RX} is less than a higher-layer configured threshold and the priority value P_{RX} is less than the priority value P_{TX}. The pre-selected and reserved sidelink resource is pre-empted. A new sidelink resource is re-selected from the candidate sidelink resource set. Note that, a lower priority value indicates traffic of higher priority. Else, the resource is used/signaled for sidelink transmission.

The positioning solutions provided for release 16 target the following commercial requirements for commercial applications as shown in TABLE 3.

TABLE 3

| Requirement characteristic | Requirement target |
|---|---|
| Horizontal Positioning Error | Indoor: 3 m for 80% of the UEs |
| | Outdoor: 10 m for 80% of the UEs |
| Vertical Positioning Error | Indoor: 3 m for 80% of the UEs |
| | Outdoor: 3 m for 80% of the UEs |
| End to end latency | Less than 1 second |

To meet these requirements, RAT-dependent, RAT independent, and a combination of RAT-dependent and RAT independent positioning schemes have been considered. For the RAT-dependent positioning schemes, timing based positioning schemes as well as angle-based positioning schemes have been considered. For timing-based positioning schemes, NR supports DL time difference of arrival (DL-TDOA), using PRS for time of arrival measurements. NR also supports UL time difference of arrival (UL-TDOA), using SRS for time of arrival measurements. In Rel-18, NR introduced SL positioning, and supports SL time difference of arrival (SL-TDOA) using SL PRS.

NR also supports RTT with one or more neighboring gNBs or TRPs, as well as RTT between UEs. For angle based positioning schemes, NR exploits the beam-based air interface, supporting downlink angle of departure (DL-AoD), uplink angle of arrival (UL-AoA), as well as sidelink angle of arrival (SL-AoA). Furthermore, NR supports enhanced cell-ID (E-CID) based positioning schemes. RAT independent positioning schemes can be based on global navigation satellite systems (GNSS), WLAN (e.g., WiFi), Bluetooth, terrestrial beacon system (TBS), as well as sensors within the UE such as accelerometers, gyroscopes, magnetometers, etc. Some of the UE sensors are also known as inertial measurement unit (IMU).

As NR expands into new verticals, there is a need to provide improved and enhanced location capabilities to meet various regulatory and commercial positioning requirements. 3GPP SAI considered the service requirements for high accuracy positioning in TS 22.261 and identified seven service levels for positioning, with varying levels of accuracy (horizontal accuracy and vertical accuracy), positioning availability, latency requirement, as well as positioning type (absolute or relative).

One of the positioning service levels is relative positioning (as illustrated in 3GPP standard specification TS 22.261), with a horizontal and vertical accuracy of 0.2 m, availability of 99%, latency of 1 sec, and targeting indoor and outdoor environments with speed up to 30 km/hr and distance between UEs or a UE and a 5G positioning node of 10 m.

Rel-17 further enhanced the accuracy, latency, reliability and efficiency of positioning schemes for commercial and IIOT applications. Targeting to achieve sub-meter accuracy with a target latency less than 100 ms for commercial applications, and accuracy better than 20 cm with a target latency in the order of 10 ms for IIOT applications.

In Rel-17, 3GPP standard specification provides positioning use cases and requirements for V2X and public safety as well as identifying potential deployment and operation scenarios. The outcome of the study item is included in TR 38.845.

FIG. 7 illustrates an example of LMF 700 according to embodiments of the present disclosure. The embodiment of the LMF 700 shown in FIG. 7 is for illustration only. However, LMFs come in a wide variety of configurations, and FIG. 7 does not limit the scope of this disclosure to any particular implementation of an LMF.

As shown in FIG. 7, the LMF includes a controller/processor 705, a memory 710, and a backhaul or network interface 715.

The controller/processor 705 can include one or more processors or other processing devices that control the overall operation of the LMF 700. For example, the controller/processor 705 can support functions related to positioning and location services. Any of a wide variety of other functions can be supported in the LMF 700 by the controller/processor 705. In some embodiments, the controller/processor 705 includes at least one microprocessor or microcontroller.

The controller/processor 705 is also capable of executing programs and other processes resident in the memory, such as a basic OS. In some embodiments, the controller/processor 705 supports communications between entities, such as gNB 102 and UE 116 and supports protocols such as LTE Positioning Protocol (LPP) and (NR positioning protocol A) NRPPa. The controller/processor 705 can move data into or out of the memory 710 as required by an executing process.

The controller/processor 705 is also coupled to the backhaul or network interface 715. The backhaul or network interface 715 allows the LMF 700 to communicate with other devices or systems over a backhaul connection or over a network. The interface 715 can support communications over any suitable wired or wireless connection(s). For example, when the LMF 700 is implemented as part of a cellular communication system or wired or wireless local area network (such as one supporting 5G, LTE, or LTE-A), the interface can allow the LMF 700 to communicate with gNBs or eNBs or other network elements over a wired or wireless backhaul connection. The interface 715 includes any suitable structure supporting communications over a wired or wireless connection, such as an Ethernet or RF transceiver.

The memory 710 is coupled to the controller/processor 705. Part of the memory 710 can include a RAM, and another part of the memory 710 can include a Flash memory or other ROM. In certain embodiments, a plurality of instructions, such as a positioning or location algorithm is stored in memory. The plurality of instructions is configured to cause the controller/processor to perform the positioning or location processes and to perform positioning or location services algorithms.

V2X positioning requirements depend on the service the UE operates and are applicable to absolute and relative positioning. Use cases include indoor, outdoor and tunnel areas, within network coverage or out of network coverage; as well as with GNSS-based positioning available, or not available, or not accurate enough; and with UE speeds up to 250 km/h. There are three sets of requirements for V2X use cases; the first with horizontal accuracy in the 10 to 50 m range, the second with horizontal accuracy in the 1 to 3 m range, and the third with horizontal accuracy in the 0.1 to 0.5 m range. The 5G system can also support determining the velocity of a UE with a speed accuracy better that 0.5 m/s and a 3-Dimension direction accuracy better than 5 degrees. Public safety positioning is to support indoor and outdoor use cases, with in network coverage or out of network coverage; as well as with GNSS-based positioning available, or not available, or not accurate enough. Public safety positioning use cases target a 1-meter horizontal accuracy and a vertical accuracy of 2 m (absolute) or 0.3 m (relative).

In terms of deployment and operation scenarios for in-coverage, partial-coverage and out-of-coverage NR positioning use cases, 3GPP TR 38.845 has identified the following: (1) for network coverage, in-network coverage, partial network coverage as well as out-of-network coverage. In addition to scenarios with no GNSS and/or no network coverage; (2) a radio link: Uu interface (UL/DL interface) based solutions, PC5 interface (SL interface) based solutions and their combinations (hybrid solutions). As well as RAT-independent solutions such as GNSS and sensors; (3) a positioning calculation entity: network-based positioning when the positioning estimation is performed by the network and UE-based positioning when the positioning estimation is performed by the UE; (4) UE Type: for V2X UEs, this can be a UE installed in a vehicle, a road side unit (RSU), or a vulnerable road user (VRU). Some UEs can have distributed antennas, e.g., multiple antenna patterns that can be leveraged for positioning. UEs can have different power supply limitations, for example, VRUs or hand-held UEs have limited energy supply compared to other UEs; and (5) spectrum: this can include licensed spectrum and unlicensed spectrum for the Uu interface and the PC5 interface as well as ITS-dedicated spectrum for the PC5 interface.

In the present disclosure, procedures and signaling operation for the configuration for mesh-based positioning or crowd positioning are provided, wherein users use the positioning measurements or metrics and/or positioning location of other neighboring UEs when attempting to determine the positioning of a UE. Each UE can transmit a positioning reference signal (e.g., SL positioning reference signal) to neighboring UEs as well as positioning measurements or metrics and/or location information.

Each UE can also receive and measure positioning reference signals from neighboring UEs. In one example, the UE provides these measurements as well as its location information to neighboring UEs. In another example, the UE provides these measurements to the network, e.g., gNB or LMF. In one example a UE uses the measurements the UE performed as well as measurements and/or location information of neighboring UEs to determine its location. In another example, the network (e.g., gNB or LMF) uses the positioning measurements or metrics and/or location information provided by the UEs to collectively determine the position of the UEs.

SL is one of the promising features of NR, targeting verticals such the automotive industry, public safety, industrial internet of things (IIoT) and other commercial application. 3GPP Rel-16 is the first NR release to include sidelink through work item “5G V2X with NR sidelink” with emphasis on V2X and public safety where the requirements are met. In Rel-17, the support of SL has been expanded to other types of UEs such vulnerable road users (VRUs), pedestrian UEs (PUEs) and other types of hand-held devices, by supporting mechanisms for power saving for SL resource allocation as well as mechanisms that enhance reliability and reduce latency of SL transmissions.

In Rel-18, SL is being evolved to support SL operation in unlicensed spectrum, SL co-existence between SL LTE and SL NR in a same band and SL operation is FR2, focusing on beam management aspects, is studied. Another feature that NR supports is positioning, using the NR radio interface for performing positioning measurements or metrics to determine or assist in determining the location of a UE. NR positioning was first introduced using the Uu interface in Rel-16, through work item “NR Positioning Support.” Rel-17 further enhanced accuracy and reduced the latency of NR-based positioning through work item “NR Positioning Enhancements” as discussed in the 3GPP standard committees.

In Rel-17, a study was conducted in the RAN on “scenarios and requirements of in-coverage, partial coverage, and out-of-coverage positioning use cases” with accuracy requirements in the 10's of cm range, using the PC5 interface as well as the Uu interface for absolute and relative positioning. In Rel-18 a study item followed by a work item to study and specify SL positioning has been introduced.

In the present disclosure, methods and signaling is provided for mesh positioning. In a certain area, there can be multiple UEs performing SL positioning and possibly other types of positioning measurements or metrics. To perform SL positioning, a UE performs positioning measurements on positioning reference signals transmitted by other UEs such measurement can include RTT-based measurements (e.g., Tx-Rx time difference measurements), SL-AoA-based measurements and SL-TDOA-based measurements. In practice, these measurements are susceptible to measurements errors at the UE performing the measurements as well as errors being introduced by the UE transmitting the positioning reference signal.

For UE-based positioning, one way to mitigate these types of errors, is for a UE to have access to positioning measurements or metrics and/or location information of neighboring UEs on the positioning reference signal it is measuring this may allow the UE to correct and mitigate the effect of measurement errors.

For UE-assistance positioning and/or NG-RAN based positioning, the network (e.g., gNB or LMF) can use positioning measurements or metrics from multiple UEs when determining a location of a UE.

The present disclosure relates to a 5G/NR communication system.

This disclosure introduces signaling and methods for: (1) reporting positioning measurements or metrics and/or location information to neighboring UEs; (2) receiving positioning measurements or metrics and/or location information from neighboring UEs to use along with its own position measurements for determining the UE's location; and (3) network (e.g., gNB and LMF), uses positioning measurements or metrics from multiple UEs to determine a location of a UE.

In the present disclosure, RRC signaling (e.g., configuration by RRC signaling) includes the following: (1) RRC signaling over the Uu interface, this can be system information block (SIB)-based RRC signaling (e.g., SIB1 or other SIB) or RRC dedicated signaling that is sent to a specific UE, and/or (2) PC5-RRC signaling over the PC5 or SL interface.

In the present disclosure, MAC CE signaling includes: (1) MAC CE signaling over the Uu interface, and/or (2) MAC CE signaling over the PC5 or SL interface.

In the present disclosure, L1 control signaling includes: (1) L1 control signaling over the Uu interface, this can include (1a) DL control information (e.g., DCI on PDCCH) and/or (1b) UL control information (e.g., UCI on PUCCH or PUSCH), and/or (2) SL control information over the PC5 or SL interface, this can include (2a) first stage sidelink control information (e.g., first stage SCI on PSCCH), and/or (2b) second stage sidelink control information (e.g., second stage SCI on PSSCH) and/or (2c) feedback control information (e.g., control information carried on PSFCH).

In the present disclosure, a SL positioning reference signal refers generically to a physical reference signal transmitted on the SL interface to assist in determining a position of a SL UE based on measurements performed on the SL positioning reference signal. In one example, a SL positioning reference signal can have a physical signal structure and/or resource allocation similar to the physical signal structure and/or resource allocation of a DL PRS used in DL of the Uu interface in NR, except that the SL positioning reference signal is transmitted/received on the SL interface (PC5 interface).

In another example, a SL positioning reference signal can have a physical signal structure and/or resource allocation similar to the physical signal structure and/or resource allocation of a UL positioning SRS used in UL of the Uu interface in NR, except that SL positioning reference signal is transmitted/received on the SL interface (PC5 interface). In another example, a SL positioning reference signal can have a physical signal structure and/or resource allocation combining aspects of the physical signal structure and/or resource allocation of (1) DL PRS used in DL of the Uu interface in NR and (2) UL positioning SRS used in UL of the Uu interface in NR, except that the SL positioning reference signal is transmitted/received on the SL interface (PC5 interface). In another example, a SL positioning reference signal can have a new physical signal structure and/or resource allocation for use on the SL interface (PC5 interface). In one example the SL positioning reference signal (SL PRS) is as described in 38.211.

In one embodiment, the network can configure SL resources for SL positioning reference signal and/or SL resources for reporting SL measurements and/or UE location information. The network can further configure SL UEs to perform SL positioning measurements.

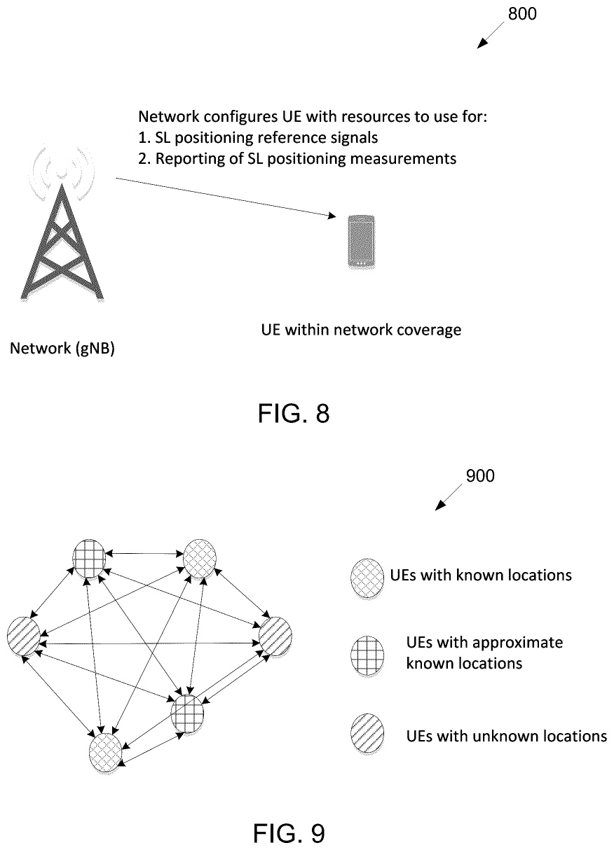

FIG. 8 illustrates an example of UE is in coverage of a network 800 according to embodiments of the present disclosure. The embodiment of the UE is in coverage of a network 800 shown in FIG. 8 is for illustration only.

A UE is in coverage of a network as shown in FIG. 8. The network can configure the UE with resources or activate or indicate to the UE resources to use for: (1) SL positioning reference signals on the SL interface (PC5 interface) and (2) reporting of SL positioning measurements or metrics and/or UL location information on the SL interface (PC5 interface).

In another embodiment, a UE can be out of coverage and the UE can determine resources to use for: (1) SL positioning reference signals on the SL interface (PC5 interface); and (2) reporting of SL positioning measurements or metrics and/or UL location information on the SL interface (PC5 interface).

In one example, a UE is (pre-)configured with the aforementioned resources. In one example, the UE determines the resources based on sensing (e.g., full sensing or partial sensing) on the SL interface and determining available resources. In one example, the UE determines the resources based on random resource selection (e.g., within a resource pool) on the SL interface.

SL Positioning reference signals are reference signals transmitted on the SL interface by a first UE. The SL positioning reference signals (SL PRS) are received by one or more second UE(s), wherein the second UE(s) performs SL positioning measurements on the SL positioning reference signals. In one example, the SL PRS is unicast from one a first UE to a second UE. In one example, the SL PRS is groupcast from a first UE to a group of second UEs. In one example, the SL PRS is broadcast from a first UE to second UEs (e.g., neighboring UEs to the first UE). SL Positioning measurements or metrics are measurements that aid in finding the position of a SL UE, e.g., the absolute position of the first SL UE and/or the absolute position of the second SL UE, and/or the relative of position of the first SL UE to the second SL UE and/or the relative position of the second SL UE to the first SL UE. Absolute position is defined in a frame of reference, e.g., the Global frame of reference (e.g., using latitude and longitude and/or elevation).

SL positioning measurements or metrics can include one or more of the following: (1) SL reference signal time difference (SL RSTD), e.g., the time difference between SL PRS receive timing at a first UE of UE i and UE j. (2) SL relative time of arrival (SL RTOA), for example, the time difference between a SL positioning reference signal received by a UE and a reference time; (3) SL reference signal receive power (SL RSRP) of a SL positioning reference signal; (4) SL reference signal receive path power (SL RSRPP) of a SL positioning reference signal. This refers to the power of an i-th path of the channel response; (5) SL angle of arrival (SL AoA) of a SL positioning reference signal; (6) SL Rx-Tx time difference, for example, this can be the difference between the receive time of a first SL positioning reference signal and the transmit time of a second SL positioning reference signal; (7) SL reference signal carrier phase (SL RSCP) of a SL positioning reference signal; (8) SL reference signal phase carrier difference (SL RSCPD) e.g., the carrier phase difference between carrier phase of SL PRS of UE i and that of UE j received at the UE performing the phase measurements; and (9) SL angle of departure (SL AoD) of a SL positioning reference signal.

FIG. 9 illustrates an example of multiple UEs 900 according to embodiments of the present disclosure. The embodiment of the multiple UEs 900 shown in FIG. 9 is for illustration only.

In an area, there can be multiple UEs as illustrated in FIG. 9. One or more of the following categories of UE can be provided: (1) UEs with a known location. For example, these can be anchor UEs or positioning reference unit (PRU) UEs or roadside unit (RSU) UEs, whose location is known and/or pre-determined; (2) UEs with an approximate known location. For example, these are UEs that used positioning measurements or metrics to determine the position of the UE, or where informed of the position by a network entity (e.g., gNB or LMF) for example based on positioning measurements or metrics; and (3) UEs with unknown locations.

In one example, a UE transmits a SL positioning reference signal. The SL positioning reference signal can be received by one or more of neighboring UEs.

In one example, a UE transmits a SL positioning reference signal. The SL positioning reference signal can be received by one or more of neighboring UEs. The SL positioning reference signal is broadcast to all neighboring UEs.

In one example, a UE transmits a SL positioning reference signal (SL PRS). The SL positioning reference signal can be received by one or more of neighboring UEs. The SL positioning reference signal is groupcast to neighboring UEs, wherein UEs in the groupcast set can receive the SL positioning reference signal. The groupcast can be (pre-)configured. In one example, a UE can groupcast one SL positioning reference signal. In one example, a UE can groupcast a first SL positioning reference signal to a first group of UEs and can groupcast a second SL positioning reference signal to a second group of UEs, and so on. In one example, the members of the groupcast set are part of a closed subscriber group. In one example, different time (e.g., slot or symbol or subframe or frame) resources or occasions are used for the different SL PRS. In one example, different frequency (e.g., PRB or sub-channel or sub-carrier) resources or occasions are used for the different SL PRS. In one example, different time and/or frequency resources or occasions are used for the different SL PRS. In one example, a resource can also be determined based on the comb and cyclic shift of the SL PRS. In one example, a resource can also be determined based on scrambling code ID or sequence ID used for the SL PRS.

In one example, a UE transmits a SL positioning reference signal. The SL positioning reference signal can be received by a neighboring UEs. The SL positioning reference signal is unicast to a neighboring UEs. In one example, a UE can unicast a first SL positioning reference signal to a first UE, and a second SL positioning reference signal to a second UE, and so on. In one example, different time (e.g., slot or symbol or subframe or frame) resources or occasions are used for the different SL PRS. In one example, different frequency (e.g., PRB or sub-channel or sub-carrier) resources or occasions are used for the different SL PRS. In one example, different time and/or frequency resources or occasions are used for the different SL PRS. In one example, a resource can also be determined based on the comb and cyclic shift of the SL PRS. In one example, a resource can also be determined based on scrambling code ID or sequence ID used for the SL PRS.

In one example, the resources for the SL positioning reference signal are pre-configured and/or configured by higher layers (e.g., RRC layer) and/or configured or indicated by the MAC Layer and/or physical layer.

In one example, the resources for SL positioning reference signal are determined based on sensing (e.g., full sensing or partial sensing) on the SL interface e.g., in a resource pool and determining available candidate resources for SL positioning reference signal transmission and selecting resources among the available candidate resources for SL positioning reference signal transmission. In one example, the resources for SL positioning reference signal are determined based on random resource selection (e.g., no sensing) on the SL interface e.g., in a resource pool.

In one example, the SL positioning reference signal is transmitted in a dedicated resource pool for SL positioning reference signal transmission.

In one example, the SL positioning reference signal is transmitted in a dedicated resource pool for SL positioning. For example, the resource pool can include SL positioning reference signal transmissions and positioning reports (e.g., SL measurements and/or UE location information).

In one example, the SL positioning reference signal is transmitted in a shared resource pool with SL communications.

In one example, a UE transmits a positioning report on a radio interface. In one example, the radio interface is a SL interface (e.g., PC5 interface).

In one example, a UE transmits a positioning report. The positioning report can include one or more of the following information: (1) positioning measurements or metrics and (2) UL location information.

In one example, a UE transmits a positioning report. The container for the positioning report can be conveyed by one of: (1) a RRC signaling; (2) MAC CE; (3) first and/or second stage SL control information (SCI); and (4) a combination of MAC CE and second stage SL control information (SCI). In one example, the same information is included in the MAC CE and second stage SCI. In another example, the information in the MAC CE and second stage SCI can be different. In one example, if the information payload is larger than (or larger than or equal to) a threshold (e.g., 140 bits) only MAC CE is used to convey the positioning report, else both MAC CE and second stage SCI are used to convey the positioning report. In one example, if the information payload is larger than (or larger than or equal to) a threshold (e.g., 140 bits) MAC CE is used to convey the positioning report, else second stage SCI is used to convey the positioning report. The threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value (e.g., 140 bits) is used.

In one example, a UE reports positioning measurements or metrics to neighboring UEs. The positioning measurements or metrics can include one or more of the following examples. In the following a resource for SL PRS can be a time resource or a frequency resource or a time and frequency resource. In one example, a resource for SL PRS can also be determined based on the comb and cyclic shift of the SL PRS. In one example, a resource for SL PRS can also be determined based on scrambling code ID or sequence ID used for the SL PRS,

In one example, a time of arrival of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, Rx-Tx time difference of SL positioning reference signal long with an indication (or identity) of the UE from which the SL positioning reference signal is transmitted. In one example, a time stamp of the measurement (e.g., slot or symbol or time occasion or resource of the Rx measurement and/or Tx measurement) is also included.

In one example, a time difference between two SL positioning reference signals transmitted from two UEs, along with an indication (or identity) of each UE from which the SL positioning reference signal is transmitted. In one example, a time stamp of the measurement (e.g., slot or slots or symbol(s) or time occasion(s) or resource(s) of the measurement) is also included.

In one example, an angle of arrival of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, a carrier phase of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, a carrier phase difference between two SL positioning reference signals transmitted from two UEs, along with an indication (or identity) of each UE from which the SL positioning reference signal is transmitted. In one example, a time stamp of the measurement (e.g., slot or slots or symbol(s) or time occasion(s) or resource(s) of the measurement) is also included.

In one example, RSRP of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, RSRPP of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, one or more of the aforementioned measurements is included if the RSRP (or RSRPP e.g., based on the largest or first multi-path RSRPP) or SINR of a corresponding SL positioning reference signal is above a threshold. Wherein, the threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value is used. In one example, if the threshold is not configured, the threshold criteria is not applied.

In one example, one or more of the aforementioned measurements is included for N UEs. Wherein, N can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if N is not configured a default value is used. In one example, the N UEs are those with the largest RSRP or RSRPP (e.g., based on the largest or first multi-path RSRPP) or SINR.

In one example, one or more of the aforementioned measurements is included for up to N UEs, with RSRP (or RSRPP e.g., based on the largest or first multi-path RSRPP) or SINR exceeding a threshold. In one example, if more than N UEs have RSRP (or RSRPP) or SINR exceed a threshold, the N UEs with the largest RSRP (or RSRPP) or SINR are reported. Wherein, N can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if N is not configured a default value is used. The threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value is used. In one example, if the threshold is not configured, the threshold criteria is not applied.

In one example, a UE reports location information to neighboring UEs. The location information can include one or more of the following: (1) UE location information, e.g., absolute positioning information or relative positioning information relative to another UE or relative to a TRP or relative to a (positioning reference unit) PRU or relative to an RSU and (2) an indicator on accuracy (or confidence level) of location information. For example, this can be high accuracy or low accuracy. In another example, the accuracy can be the margin of error or tolerance or uncertainty of the location information. In one example, the UE reports positioning measurements or metrics as aforementioned in a first report and UE reports location information as aforementioned in a second report. In one example, the UE reports positioning measurements or metrics as aforementioned and location information as aforementioned in one report.

In one example, the accuracy is determined based on device type as aforementioned, for example, this can be based on configuration or pre-configuration. In one example, the accuracy is determined based on the reliability of the signals used to perform the measurement (e.g., SL PRS or DL PRS), for example if the signal(s) used for determining the UE's location have an RSRP or RSRPP or SINR above a threshold, the accuracy can be high. In one example, the accuracy is determined based on indication from the network (e.g., LMF or gNB), e.g., when the location of the UE is being provided by the network. In one example, the accuracy is determined based on indication from another UE e.g., when the location of the UE is being provided by the other UE or when the UE uses positioning metrics provided by the other UE. In one example, the accuracy is determined based on the precision of multiple location measurements performed by the UE or informed to the UE, for example, multiple location measurements from different source with high precision (close to each other) can indicate high accuracy of the UE's location.

In one example, a UE transmits a positioning report. The positioning report can be received by one or more of neighboring UEs.

In one example, a UE transmits a positioning report. The positioning report can be received by one or more of neighboring UEs. The positioning report is broadcast to all neighboring UEs.

In one example, a UE transmits a positioning report. The positioning report can be received by one or more of neighboring UEs. The positioning report is groupcast to neighboring UEs, wherein UEs in the groupcast set can receive the positioning report. The groupcast can be (pre-)configured. In one example, a UE can groupcast one positioning report. In one example, a UE can groupcast a first positioning report to a first group of UEs and can groupcast a second positioning report to a second group of UEs, and so on. In one example, the members of the groupcast set are part of a closed subscriber group.

In one example, a UE transmits a positioning report. The positioning report can be received by a neighboring UEs. The positioning report is unicast to a neighboring UEs. In one example, a UE can unicast a first positioning report to a first UE, and a second positioning report signal to a second UE, and so on.

In one example, the resources for the positioning report are pre-configured and/or configured by higher layers (e.g., RRC layer) and/or configured or indicated by the MAC Layer and/or physical layer.

In one example, the resources for positioning report are determined based on sensing (e.g., full sensing or partial sensing) on the SL interface e.g., in a resource pool and determining available candidate resources for positioning report transmission and selecting resources among the available candidate resources for positioning report transmission. In one example, the resources for positioning report are determined based on random resource selection (e.g., no sensing) on the SL interface e.g., in a resource pool.

In one example, the positioning report is transmitted in a dedicated resource pool for positioning report transmission.

In one example, the SL positioning reference signal is transmitted in a dedicated resource pool for SL positioning. For example, the resource pool can include SL positioning reference signal transmissions and positioning reports (e.g., SL measurements and/or UE location information).

In one example, the positioning report is transmitted in a shared resource pool with SL communications.

In one example, a UE receives a positioning report and uses the positioning report along with the positioning measurement performed on received SL positioning reference signal to perform positioning.

In one example, a UE transmits a positioning report on a radio interface. In one example, the radio interface is an UL interface (e.g., UL Uu interface).

In one example, a UE transmits a positioning report on a radio interface. In one example, the radio interface is an UL interface (e.g., UL Uu interface). In one example, the destination of the positioning report is a gNB (or base station or TRP).

In one example, a UE transmits a positioning report on a radio interface. In one example, the radio interface is an UL interface (e.g., UL Uu interface). In one example, the destination of the positioning report is an LMF.

In one example, a UE transmits a positioning report. The positioning report can include one or more of the following information: (1) positioning measurements or metrics and (2) UL location information.

In one example, a UE transmits a positioning report. The container for the positioning report can be conveyed by one of: (1) an RRC signaling; (2) MAC CE; (3) uplink control information (UCI) on PUCCH or on PUSCH; and (4) a combination of MAC CE and Uplink control information (UCI). In one example, the same information is included in the MAC CE and UCI. In another example, the information in the MAC CE and UCI can be different. In one example, if the information payload is larger than (or larger than or equal to) a threshold (e.g., 140 bits) only MAC CE is used to convey the positioning report, else both MAC CE and UCI are used to convey the positioning report. In one example, if the information payload is larger than (or larger than or equal to) a threshold (e.g., 140 bits) MAC CE is used to convey the positioning report, else UCI is used to convey the positioning report. The threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default (e.g., 140 bits) value is used.

In one example, a UE reports positioning measurements or metrics to the network. The positioning measurements or metrics can include one or more of the following examples. In the following a resource for SL PRS can be a time resource or a frequency resource or a time and frequency resource. In one example, a resource for SL PRS can also be determined based on the comb and cyclic shift of the SL PRS. In one example, a resource for SL PRS can also be determined based on scrambling code ID or sequence ID used for the SL PRS

In one example, a time of arrival of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, Rx-Tx time difference of SL positioning reference signal long with an indication (or identity) of the UE from which the SL positioning reference signal is transmitted. In one example, a time stamp of the measurement (e.g., slot or symbol or time occasion or resource of the Rx measurement and/or Tx measurement) is also included.

In one example, time difference between two SL positioning reference signals transmitted from two UEs, along with an indication (or identity) of each UE from which the SL positioning reference signal is transmitted. In one example, a time stamp of the measurement (e.g., slot or slots or symbol(s) or time occasion(s) or resource(s) of the measurement) is also included.

In one example, an angle of arrival of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, a carrier phase of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, a carrier phase difference between two SL positioning reference signals transmitted from two UEs, along with an indication (or identity) of each UE from which the SL positioning reference signal is transmitted. In one example, a time stamp of the measurement (e.g., slot or slots or symbol(s) or time occasion(s) or resource(s) of the measurement) is also included

In one example, RSRP of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, RSRPP of a SL positioning reference signal along with an indication (or identity) of the UE from which the SL positioning reference signal is transmitted. In one example, a time stamp of the measurement (e.g., slot or symbol or time occasion or resource of the measurement) is also included.

In one example, one or more of the aforementioned measurements is included if the RSRP (or RSRPP e.g., based on the largest or first multi-path RSRPP) or SINR of a corresponding SL positioning reference signal is above a threshold. Wherein, the threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value is used. In one example, if the threshold is not configured, the threshold criteria is not applied.

In one example, one or more of the aforementioned measurements is included for N UEs. Wherein, N can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if N is not configured a default value is used. In one example, the N UEs are those with the largest RSRP or RSRPP (e.g., based on the largest or first multi-path RSRPP) or SINR.

In one example, one or more of the aforementioned measurements is included for up to N UEs, with RSRP (or RSRPP e.g., based on the largest or first multi-path RSRPP) or SINR exceeding a threshold. In one example, if more than N UEs have RSRP (or RSRPP) or SINR exceed a threshold, the N UEs with the largest RSRP (or RSRPP) or SINR are reported. Wherein, N can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if N is not configured a default value is used. The threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value is used. In one example, if the threshold is not configured, the threshold criteria is not applied.

In one example, a UE reports positioning measurements or metrics to the network. The positioning measurements or metrics can additionally include one or more of the following examples. In the following a resource for DL PRS can be a time resource or a frequency resource or a time and frequency resource. In one example, a resource for DL PRS can also be determined based on the comb and cyclic shift of the DL PRS. In one example, a resource for DL PRS can also be determined based on scrambling code ID or sequence ID used for the DL PRS

In one example, a time of arrival of a DL positioning reference signal along with an indication (or identity) of the TRP (or base station or gNB) from which the DL positioning reference signal is transmitted. In one example, a time stamp of the measurement (e.g., slot or symbol or time occasion or resource of the measurement) is also included.

In one example, Rx-Tx time difference of DL positioning reference signal long with an indication (or identity) of the TRP (or base station or gNB) from which the DL positioning reference signal is transmitted. In one example, a time stamp of the measurement (e.g., slot or symbol or time occasion or resource of the Rx measurement and/or Tx measurement) is also included.

In one example, time difference between two DL positioning reference signals transmitted from two TRPs (or base stations or gNBs), along with an indication (or identity) of each TRP (or base station or gNB) from which the DL positioning reference signal is transmitted. In one example, a time stamp of the measurement (e.g., slot or slots or symbol(s) or time occasion(s) or resource(s) of the measurement) is also included.

In one example, a time difference between a SL positioning reference signals transmitted from a UE and a DL positioning reference signals transmitted from a TRP (or base station or gNB), along with an indication (or identity) of each UE or TRP (or base station or gNB) from which the SL positioning reference signal or DL positioning reference signal is transmitted respectively. In one example, a time stamp of the measurement (e.g., slot or slots or symbol(s) or time occasion(s) or resource(s) of the measurement) is also included.

In one example, an angle of arrival of a DL positioning reference signal along with an indication (or identity) of the TRP (or base station or gNB) from which the DL positioning reference signal is transmitted. In one example, a time stamp of the measurement (e.g., slot or symbol or time occasion or resource of the measurement) is also included.

In one example, a carrier phase of a DL positioning reference signal along with an indication (or identity) of the TRP (or base station or gNB) from which the DL positioning reference signal is transmitted. In one example, a time stamp of the measurement (e.g., slot or symbol or time occasion or resource of the measurement) is also included.

In one example, a carrier phase difference between two DL positioning reference signals transmitted from two TRPs (or base stations or gNBs), along with an indication (or identity) of each TRP (or base station or gNB) from which the DL positioning reference signal is transmitted. In one example, a time stamp of the measurement (e.g., slot or slots or symbol(s) or time occasion(s) or resource(s) of the measurement) is also included.

In one example, a carrier phase difference between a SL positioning reference signals transmitted from a UE and a DL positioning reference signals transmitted from a TRP (or base station or gNB), along with an indication (or identity) of each UE or TRP (or base station or gNB) from which the SL positioning reference signal or DL positioning reference signal is transmitted respectively. In one example, a time stamp of the measurement (e.g., slot or slots or symbol(s) or time occasion(s) or resource(s) of the measurement) is also included

In one example, RSRP of a DL positioning reference signal along with an indication (or identity) of the TRP (or base station or gNB) from which the DL positioning reference signal is transmitted. In one example, a time stamp of the measurement (e.g., slot or symbol or time occasion or resource of the measurement) is also included.

In one example, RSRPP of a DL positioning reference signal along with an indication (or identity) of the TRP (or base station or gNB) from which the DL positioning reference signal is transmitted. In one example, a time stamp of the measurement (e.g., slot or symbol or time occasion or resource of the measurement) is also included.

In one example, one or more of the aforementioned measurements is included if the RSRP (or RSRPP e.g., based on the largest or first multi-path RSRPP) or SINR of a corresponding DL positioning reference signal is above a threshold. Wherein, the threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value is used. In one example, if the threshold is not configured, the threshold criteria is not applied.

In one example, one or more of the aforementioned measurements is included for M TRPs (or base station or gNB) and/or UEs. Wherein, M can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if M is not configured a default value is used. In one example, the M TRPs (or base station or gNB) and/or UEs are those with the largest RSRP or RSRPP (e.g., based on the largest or first multi-path RSRPP) or SINR.

In one example, one or more of the aforementioned measurements is included for up to M TRPs (or base station or gNB) and/or UEs, with RSRP (or RSRPP e.g., based on the largest or first multi-path RSRPP) or SINR exceeding a threshold. In one example, if more than M TRPs (or base station or gNB) and/or UEs have RSRP (or RSRPP) or SINR exceed a threshold, the M TRPs (or base station or gNB) and/or UEs with the largest RSRP (or RSRPP) or SINR are reported. Wherein, M can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if M is not configured a default value is used. The threshold can be specified in the system specifications and/or configured or updated by higher layer signaling (e.g., RRC signaling on the PC5 interface and/or Uu interface) and/or MAC CE signaling (e.g., on the PC5 interface and/or Uu interface) and/or L1 control signaling (e.g., on the PC5 interface and/or Uu interface). In one example, if the threshold is not configured a default value is used. In one example, if the threshold is not configured, the threshold criteria is not applied.

In one example, a UE reports location information to the network. The location information can include one or more of the following: (1) UE location information, e.g., absolute positioning information or relative positioning information relative to another UE or relative to a TRP or relative to a (positioning reference unit) PRU or relative to an RSU and (2) an indicator on accuracy (or confidence level) of location information. For example, this can be high accuracy or low accuracy. In another example, the accuracy can be the margin of error or tolerance or uncertainty of the location information. In one example, the UE reports positioning measurements or metrics as aforementioned in a first report and UE reports location information as aforementioned in a second report. In one example, the UE reports positioning measurements or metrics as aforementioned and location information as aforementioned in one report.

In one example, the accuracy is determined based on device type as aforementioned, for example, this can be based on configuration or pre-configuration. In one example, the accuracy is determined based on the reliability of the signals used to perform the measurement (e.g., SL PRS or DL PRS), for example if the signal(s) used for determining the UE's location have an RSRP or RSRPP or SINR above a threshold, the accuracy can be high. In one example, the accuracy is determined based on indication from the network (e.g., LMF or gNB), e.g., when the location of the UE is being provided by the network. In one example, the accuracy is determined based on indication from another UE e.g., when the location of the UE is being provided by the other UE or when the UE uses positioning metrics provided by the other UE. In one example, the accuracy is determined based on the precision of multiple location measurements performed by the UE or informed to the UE, for example, multiple location measurements from different source with high precision (close to each other) can indicate high accuracy of the UE's location.

In one example, the resources for the positioning report are pre-configured and/or configured by higher layers (e.g., RRC layer) and/or configured or indicated by the MAC Layer and/or physical layer. In one example, the UE initiates the transmission of the positioning report.

In one example, the gNB (or base station or TRP) uses the positioning reports from a set of UEs to determine the location information or a UE. The gNB (or base station or TRP) may additionally use positioning measurements or metrics the gNB performed on the set of UEs or the UE. Wherein the positioning measurements or metrics at the gNB (or base station or TRP) are performed using UL positioning reference signal (e.g., positioning SRS).

In one example, the LMF uses the positioning reports from a set of UEs to determine the location information or a UE. The LMF may additional use positioning measurements or metrics performed by one or more gNBs (or base stations or TRPs) on the set of UEs or the UE. Wherein the positioning measurements or metrics at the gNB (or base station or TRP) are performed using UL positioning reference signal (e.g., positioning SRS).

In the present disclosure provides: (1) mesh-based positioning, wherein a location of a UE can be determined based on positioning measurements or metrics made at other UEs as well as (or instead of) its own positioning measurement and (2) signaling for Mesh-based positioning on the SL interface including a positioning report with positioning measurements or metrics and/or location information.

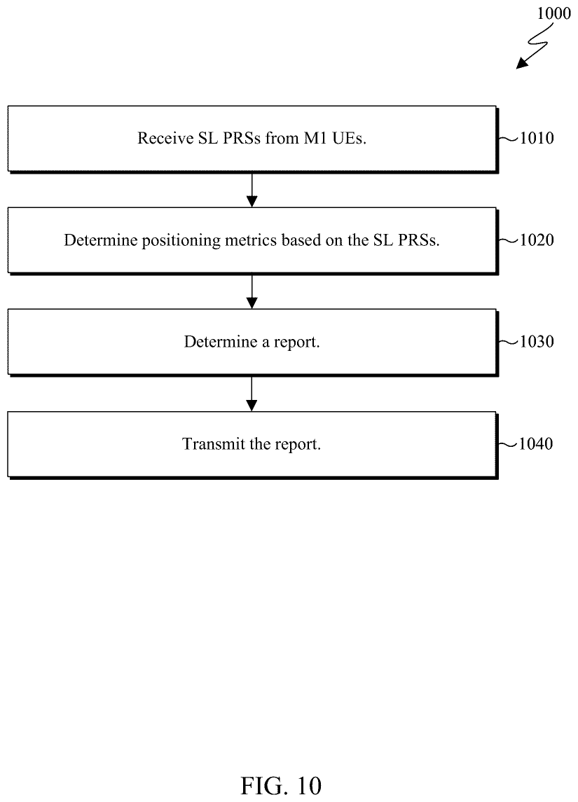

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by another of the UEs 111-116 of FIG. 1 or by any of the BSs 101-103 of FIG. 1, such as BS 102 of FIG. 2. The method 1000 is for illustration only and other embodiments can be used without departing from the scope of the present disclosure.

The method 1000 begins with the UE receiving SL PRSs from M1 UEs, respectively (1010). For example, in 1010, M1>=2. The UE then determines positioning metrics based on the SL PRSs (1020). In various embodiments, a positioning metric from the positioning metrics is a RSTD between two SL PRSs from two of the M2 UEs.

The UE then determines a report (1030). For example, in 1030, the report includes the positioning metrics corresponding to M2 UEs, respectively, from the M1 UEs; time-stamps associated with the positioning metrics, respectively; and IDs of the M2 UEs, respectively. In various embodiments, when one of the first SL PRSs of one of the M1 UEs has a quality metric higher than or equal to a threshold, a positioning metric, corresponding to the one M1 UE, from the positioning metrics is included in the first report.

The UE then transmits the report (1040). For example, in 1040, the UE may transmit the report to a different UE than any of the aforementioned UEs or to one or more of the M1 UEs. In various embodiments, the UE may determine resources based on sensing where the first report is transmitted based on the resources. In various embodiments, the UE may receive a configuration indicating resources, where the first report is transmitted based on the resources. In various embodiments, the UE may receive a configuration indicating resources and transmit a second report based on the resources. The second report includes location information of the UE.

In various embodiments, the UE may also transmit a second report to the third UE or one of the M2 UEs where this second report includes location information of the UE. In various embodiments, the second report includes a quality metric indicating an accuracy of the location information.

In various embodiments, the UE may also receive second SL PRSs from fourth UEs, respectively, and receive, from one or more of the fourth UEs, a second report. The second report includes: second positioning metrics corresponding to M3 UEs, respectively, from the fourth UEs, where M3>=1, second time-stamps associated with the second positioning metrics, respectively, and second IDs of the M3 UEs, respectively.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive first sidelink (SL) positioning reference signals (PRSs) from M1 UEs, respectively, where M1>=2; and
a processor operably coupled to the transceiver, the processor configured to:
determine positioning metrics based on the first SL PRSs, and
determine a first report, wherein the first report includes:
the positioning metrics corresponding to M2 UEs, respectively, from the M1 UEs,
time-stamps associated with the positioning metrics, respectively, and identities (IDs) of the M2 UEs, respectively,
wherein the transceiver is further configured to transmit the first report to a third UE or one of the M1 UEs.

2. The UE of claim 1, wherein:
the transceiver is further configured to transmit a second report to the third UE or one of the M1 UEs, and
the second report includes location information of the UE.

3. The UE of claim 2, wherein the second report includes a quality metric indicating an accuracy of the location information.

4. The UE of claim 1, wherein a positioning metric from the positioning metrics is a reference signal time difference (RSTD) between two SL PRSs from two of the M2 UEs.

5. The UE of claim 1, wherein, when one of the first SL PRSs of one of the M1 UEs has a quality metric higher than or equal to a threshold, a positioning metric, corresponding to the one M1 UE, from the positioning metrics is included in the first report.

6. The UE of claim 1, wherein:
the processor is further configured to determine resources based on sensing, and
the first report is transmitted based on the resources.

7. The UE of claim 1, wherein:
the transceiver is further configured to receive a configuration indicating resources, and
the first report is transmitted based on the resources.

8. The UE of claim 1, wherein:
the transceiver is further configured to:
receive a configuration indicating resources, and
transmit a second report based on the resources, and
the second report includes location information of the UE.

9. The UE of claim 1, wherein:
the transceiver is further configured to:
receive a second SL PRS from a fourth UE, and
receive, from the fourth UE, a second report, and
the second report includes:
one or more second positioning metrics corresponding to M3 UEs, respectively, where M3>=1,
one or more second time-stamps associated with the one or more second positioning metrics, respectively, and
one or more second IDs of the M3 UEs, respectively.

10. A base station (BS), comprising:
a processor; and
a transceiver operably coupled to the processor, the transceiver configured to:
transmit a configuration indicating resources, and
receive a report via the resources, wherein the report includes:
positioning metrics corresponding to M user equipments (UEs), respectively, where M>=1,
time-stamps associated with the positioning metrics, respectively, and
identities (IDs) of the M UEs, respectively.

11. The BS of claim 10, wherein:
the transceiver is further configured to:
receive a configuration indicating resources, and
transmit a second report via the resources, and
the second report includes location information of a UE.

12. A method of operating a user equipment (UE), the method comprising:
receiving first sidelink (SL) positioning reference signals (PRSs) from M1 UEs, respectively, where M1>=2;
determining positioning metrics based on the first SL PRSs;
determining a first report, wherein the first report includes:
the positioning metrics corresponding to M2 UEs, respectively, from the M1 UEs,
time-stamps associated with the positioning metrics, respectively, and
identities (IDs) of the M2 UEs, respectively; and
transmitting the first report to a third UE or one of the M1 UEs.

13. The method of claim 12, further comprising:
transmitting a second report to the third UE or one of the M1 UEs,
wherein the second report includes location information of the UE.

14. The method of claim 13, wherein the second report includes a quality metric indicating an accuracy of the location information.

15. The method of claim 12, wherein a positioning metric from the positioning metrics is a reference signal time difference (RSTD) between two SL PRSs from two of the M2 UEs.

16. The method of claim 12, wherein, when one of the first SL PRSs of one of the M1 UEs has a quality metric higher than or equal to a threshold, a positioning metric, corresponding to the one M1 UE, from the positioning metrics is included in the first report.

17. The method of claim 12, further comprising:
determining resources based on sensing,
wherein the first report is transmitted based on the resources.

18. The method of claim 12, further comprising:
receiving a configuration indicating resources; and
transmitting the first report using the resources.

19. The method of claim 12, further comprising:
receiving a configuration indicating resources; and
transmitting a second report based on the resources,
wherein the second report includes location information of the UE.

20. The method of claim 12, further comprising:
receiving a second SL PRS from a fourth UE, and
receiving, from the fourth UEs, a second report,
wherein the second report includes:
one or more second positioning metrics corresponding to M3 UEs, respectively, where M3>=1,
one or more second time-stamps associated with the one or more second positioning metrics, respectively, and
one or more second IDs of the M3 UEs, respectively.
